(19) United States
(12) Patent Application Publication
(10) Pub. No.: US 2019/0031422 A1
(43) Pub. Date: Jan. 31, 2019

(54) DESICCANT CONTAINER WITH MOISTURE-INDICATING ABILITY

(71) Applicant: OK BIOTECH CO. LTD., Hsinchu City (TW)

(72) Inventors: Chia-Te Lai, Hsinchu City (TW); An-Yuan Lee, Hsinchu City (TW)

(21) Appl. No.: 15/919,824

(22) Filed: Mar. 13, 2018

(30) Foreign Application Priority Data
Jul. 25, 2017 (TW) 106124941

(51) Int. Cl. B65D 81/26; B65D 21/02

(52) U.S. Cl. CPC B65D 81/264; A61J 1/00; B65D 21/0233

(57) ABSTRACT

A desiccant container with moisture-indicating ability includes an inner container body, a container body, a cover member and a plurality of dry discoloration elements. The inner container body is to store a plurality of biological test pieces. The container body includes an accommodation portion to accommodate the inner container body, and a moisture-indicating portion is formed between the inner container body and the container body. The cover member engages exteriorly the container body. The dry discoloration elements, disposed in the moisture-indicating portion, are used to absorb moisture and then discolor. At least one of the inner container body and the container body is formed as a peeping structure made of a transparent material for inspecting coloring of the dry discoloration elements in the moisture-indicating portion.

### CROSS REFERENCE TO RELATED APPLICATION

This application claims the benefit of Taiwan Patent Application Serial No. 106124941, filed Jul. 25, 2017, the subject matter of which is incorporated herein by reference.

### BACKGROUND OF THE INVENTION

### (1) Field of the Invention

The invention relates to a desiccant container, and more particularly to the desiccant container with moisture-indicating ability.

### (2) Description of the Prior Art

Generally, damped biological test pieces cannot reveal accurate digits on a biological instrument. Thereupon, a drying container is usually applied to store the biological test pieces so as to avoid possible dampness, and thus to ensure qualities of the biological test pieces.

Typically, the drying container is usually made of an opaque plastics, and thus accidental dampness of the biological test pieces thereinside cannot be observed without opening the drying container. In the case that the biological test pieces stored in the drying container are damped, then qualities thereof would be inevitably degraded, and thus, as a consequence, testing on the biological instrument with these damped biological test pieces would be quite possible to produce false readings, even handled by professional medical personnel. In addition, while shopping around the biological test pieces packed inside the drying container in an ordinary marketplace, since the dry state of the biological test pieces in the drying container cannot be determined by judging simply upon the appearance of the drying container. Thus, the purchase willingness thereupon would be adversely affected. Actually, even manufacturers and/or retailers of the biological test pieces can't investigate anytime the state inside the drying container on the shelf, and thus conditions of the merchandise biological test pieces would be highly questioned and practically left no results.

### SUMMARY OF THE INVENTION

Accordingly, it is an object of the present invention to provide a desiccant container that is furnished with peeping structures to various portions of the container. Thereupon, the peeping structures can be applied to inspect whether or not dry discoloration elements in the drying container have already been discolored, and further to determine if or not the biological test pieces are damped or moisturized by judging colors of the dry discoloration elements.

It is another object of the present invention to provide the dry discoloration elements to the desiccant container for maintaining internal dryness and for indicating the internal dryness by absorbing moisture to discolor.

It is a further object of the present invention to provide an arrangement of the non-translucent structures, such that the biological test pieces can be prevented from sunshine so as to ensure qualities of the biological test pieces.

In the present invention, the desiccant container with moisture-indicating ability includes an inner container body, a container body, a cover member and a plurality of dry discoloration elements. The inner container body is to store a plurality of biological test pieces. The container body includes an accommodation portion to accommodate the inner container body, and a moisture-indicating portion is formed between the inner container body and a bottom portion or an inner wall of the container body. The cover member engages exteriorly the container body. The dry discoloration elements, disposed in the moisture-indicating portion, are used to absorb moisture and then discolor. At least one of the inner container body and the container body is formed as a peeping structure made of a transparent material for inspecting coloring of the dry discoloration elements in the moisture-indicating portion.

In another aspect of the present invention, the desiccant container with moisture-indicating ability includes an inner container body, a container body, a cover member and a plurality of dry discoloration elements. The inner container body is to store a plurality of biological test pieces. The container body is to accommodate the inner container body. The cover member, engaging exteriorly the container body, includes a moisture-indicating portion formed as a peeping structure made of a transparent material. The dry discoloration elements, disposed in the moisture-indicating portion, are used to absorb moisture and then discolor. Coloring of each of the dry discoloration elements is inspected through the moisture-indicating portion.

In a further aspect of the present invention, the desiccant container with moisture-indicating ability includes an inner container body, a container body, a cover member and a plurality of dry discoloration elements. The inner container body is to store a plurality of biological test pieces. The container body includes an accommodation portion to accommodate the inner container body, and a moisture-indicating portion is formed between the inner container body and a bottom portion or an inner wall of the container body. The cover member engages exteriorly the container body. The dry discoloration elements, disposed in the moisture-indicating portion, are used to absorb moisture and then discolor. Coloring of each of the dry discoloration elements is inspected through the moisture-indicating portion.

All these objects are achieved by the desiccant container with moisture-indicating ability described below.

### BRIEF DESCRIPTION OF THE DRAWINGS

The present invention will now be specified with reference to its preferred embodiment illustrated in the drawings, in which:

FIG. 1 is a schematically perspective view of a preferred desiccant container with moisture-indicating ability in accordance with the present invention;

FIG. 2 is a schematically exploded view of FIG. 1;

FIG. 3 is a schematic view of a first embodiment of the preferred desiccant container with moisture-indicating ability of FIG. 1;

FIG. 4 is a schematic view of a second embodiment of the preferred desiccant container with moisture-indicating ability of FIG. 1;

FIG. 5 is a schematic view of a third embodiment of the preferred desiccant container with moisture-indicating ability of FIG. 1;

FIG. 6 is a schematic view of a fourth embodiment of the preferred desiccant container with moisture-indicating ability of FIG. 1;

FIG. 7 is a schematic view of a fifth embodiment of the preferred desiccant container with moisture-indicating ability of FIG. 1;

FIG. 8 is a schematically exploded view of FIG. 7; and

FIG. 9 is a schematic view of a sixth embodiment of the preferred desiccant container with moisture-indicating ability of FIG. 1.

### DESCRIPTION OF THE PREFERRED EMBODIMENT

The invention disclosed herein is directed to a desiccant container with moisture-indicating ability. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

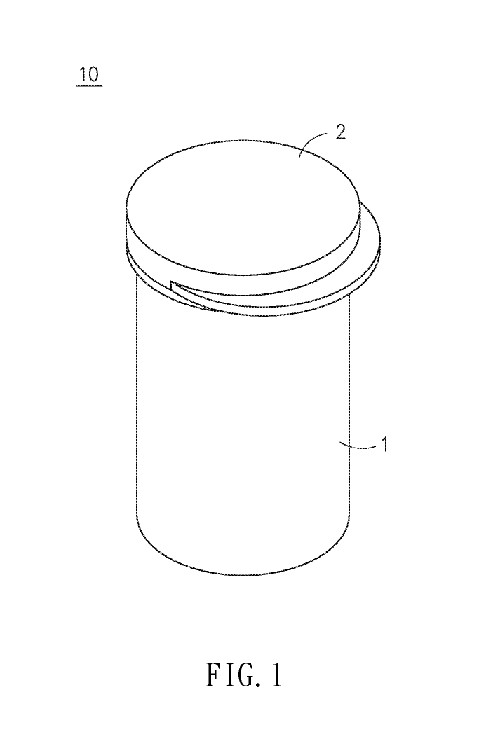

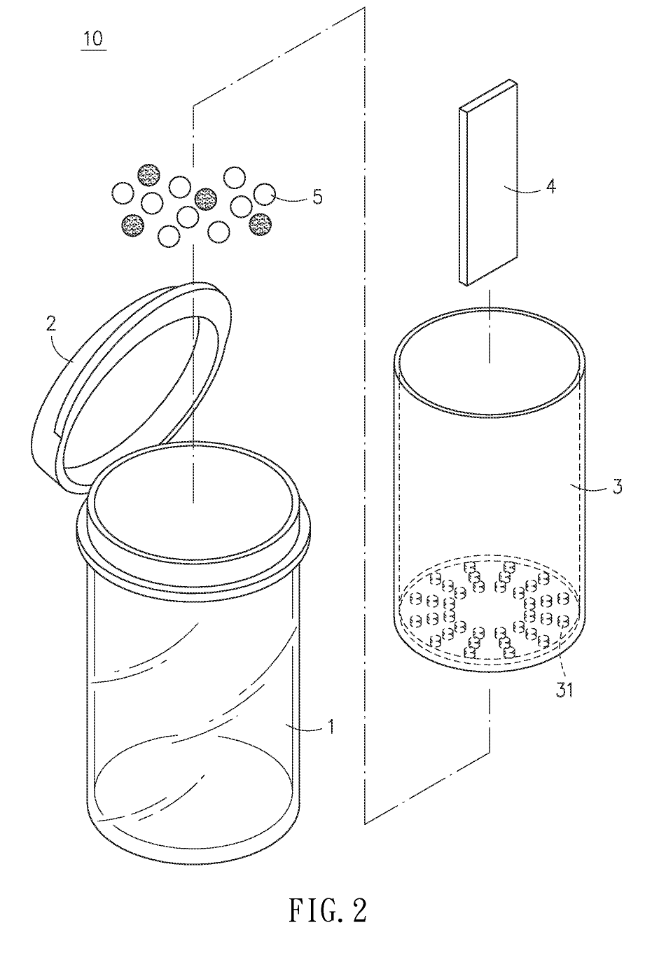

Refer now to FIG. 1 and FIG. 2; where FIG. 1 is a schematically perspective view of a preferred desiccant container with moisture-indicating ability in accordance with the present invention, and FIG. 2 is a schematically exploded view of FIG. 1.

The preferred desiccant container with moisture-indicating ability 10 of the present invention includes a container body 1 and a cover member 2 connecting exteriorly with the container body 1.

The container body 1 has a bottom portion for disposing a plurality of dry discoloration elements 5. In the present invention, the dry discoloration elements 5 include at least discoloration-type silicone desiccants and drying agents, by which degrees of dryness inside the desiccant container with moisture-indicating ability 10 can be maintained and indicated by absorbing moisture to discolor. In addition, the dry discoloration element 5 can be, but not limited to, a non-translucent structure. In one embodiment, the dry discoloration element 5 is made of a water glass (a soluble alkali-silicate material). In the art, the water glass is featured in having a blue appearance while in dry and a red appearance while in wet. Hence, even to ordinary people, such as a consumer or a salesman, the determination whether or not the biological test pieces are damped or moisturized can be easily made by judging the coloring of the water glass.

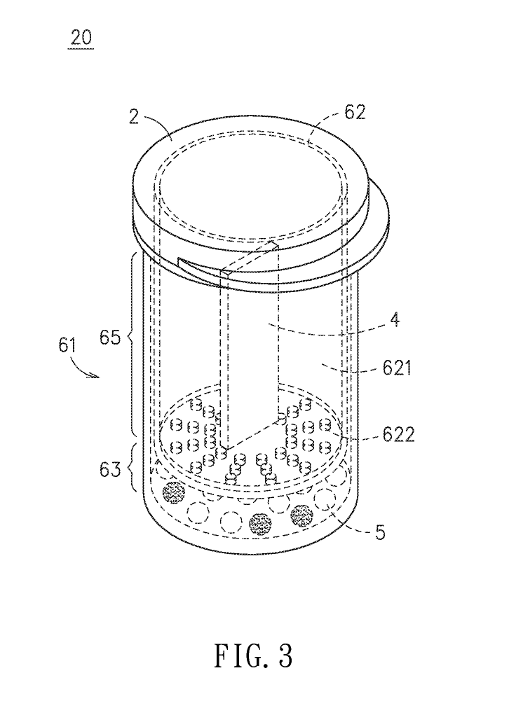

The container body 1 is to receive an inner container body 3. A bottom portion of the inner container body 3 is furnished with a plurality of ventilation holes 31, and the inner container body 3 is to accommodate a plurality of biological test pieces 4. As shown in FIG. 2, the desiccant container with moisture-indicating ability 10 includes at least the container body 1, the cover member 2 for engaging and sealing the container body 1, the inner container body 3 inside the container body 1, and the plurality of dry discoloration elements 5 provided between the container body 1 and the inner container body 3. In the following description, six exemplary embodiments derived from the aforesaid preferred desiccant container with moisture-indicating ability 10 are provided and schematically depicted individually in FIG. 3 to FIG. 9.

Referring now to FIG. 3, a schematic view of a first embodiment of the preferred desiccant container with moisture-indicating ability of FIG. 1 is shown.

In this embodiment, the desiccant container with moisture-indicating ability 20 includes a container body 61, an inner container body 62, a cover member 2 and a plurality of dry discoloration elements 5. The container body 61 is formed as a non-peeping structure made of a non-transparent material with a specific color, and further includes an accommodation portion 65 and a moisture-indicating portion 63. The accommodation portion 65 located in the container body 61 is to receive thereinside the inner container body 62. The inner container body 62 is also formed as another peeping structure made of a transparent material. The moisture-indicating portion 63 is located between the inner container body 62 and the bottom portion of the container body 61. The bottom portion of the inner container body 62, formed as a plate structure, is furnished with a plurality of ventilation holes 622, where each of the ventilation holes 622 is to communicate spatially an accommodation space 621 of the inner container 62 to the moisture-indicating portion 63. The accommodation space 621 is used to store the plurality of biological test pieces 4. In addition, a plurality of dry discoloration elements 5 are provided into the moisture-indicating portion 63. In the present invention, the dry discoloration element 5 is applied to absorb moisture and then discolor.

Upon the aforesaid arrangement, as the cover member 2 is opened, through the inner container body 62 (a peeping structure), a coloring state of the dry discoloration elements 5 in the moisture-indicating portion 63 can be observed.

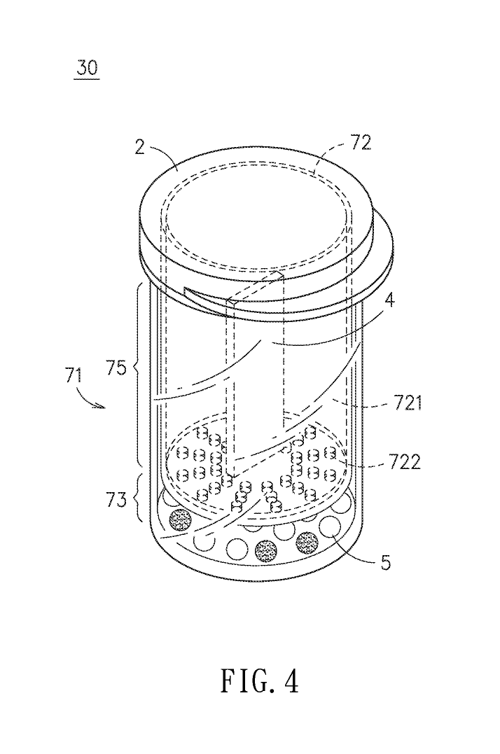

Referring now to FIG. 4, a schematic view of a second embodiment of the preferred desiccant container with moisture-indicating ability of FIG. 1 is shown.

In this embodiment, the desiccant container with moisture-indicating ability 30 includes a container body 71, an inner container body 72, a cover member 2 and a plurality of dry discoloration elements 5. The container body 71, formed as a peeping structure made of a transparent material, includes an accommodation portion 75 and a moisture-indicating portion 73. The accommodation portion 75 in the container body 71 is used to accommodate the inner container body 72. The inner container body 72 is formed as a non-peeping structure made of a non-transparent material. The moisture-indicating portion 73 is located between the inner container body 72 and a bottom portion of the container body 71. Further, the inner container body 72 has a bottom portion furnished with a plurality of ventilation holes 722 for communicating spatially to the moisture-indicating portion 73. The inner container body 72 has an accommodation space 721 for storing a plurality of biological test pieces 4. A plurality of dry discoloration elements 5 are located in the moisture-indicating portion 73, for absorbing moisture and then discoloring.

Upon the aforesaid arrangement, through the container body 71 (a peeping structure), a coloring state of the dry discoloration elements 5 in the moisture-indicating portion 73 can be observed.

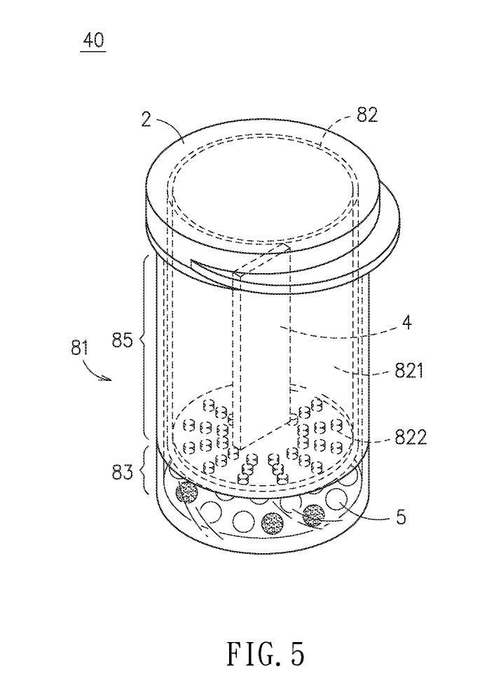

Referring now to FIG. 5, a schematic view of a third embodiment of the preferred desiccant container with moisture-indicating ability of FIG. 1 is shown.

In this embodiment, the desiccant container with moisture-indicating ability 40 includes a container body 81, an inner container body 82, a cover member 2 and a plurality of dry discoloration elements 5. The container body 81 includes an accommodation portion 85 and a moisture-indicating portion 83. The accommodation portion 85 in the container body 81 is used to accommodate the inner container body 82. The inner container body 82 has an accommodation space 821 for storing a plurality of biological test pieces 4. The moisture-indicating portion 83 is formed between the inner container body 82 and a bottom portion of the container body 81. A plurality of ventilation holes 822 are structured at a bottom portion of the inner container body 82, through which they moisture-indicating portion 83 can communicate spatially with the accommodation space 821 of the inner container body 82. The accommodation portion 85 of the container body 81 is formed as a non-peeping structure made of a non-transparent material, while the moisture-indicating portion 83 of the container body 81 is formed as a peeping structure made of a transparent material. In addition, the inner container body 82 is formed as a non-peeping structure made of a non-transparent material or a peeping structure made of a transparent material. The plurality of dry discoloration elements 5 are located inside the moisture-indicating portion 83, for absorbing moisture and then discoloring.

Upon the aforesaid arrangement, through the moisture-indicating portion 83 (a peeping structure), a coloring state of the dry discoloration elements 5 in the moisture-indicating portion 83 can be observed.

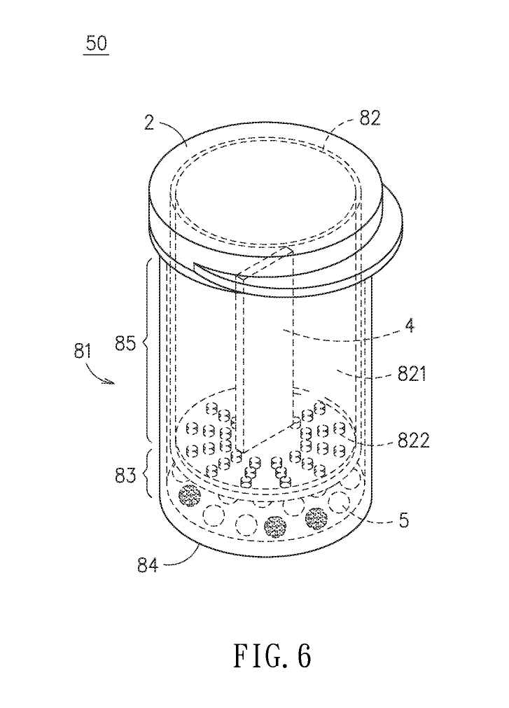

Referring now to FIG. 6, a schematic view of a fourth embodiment of the preferred desiccant container with moisture-indicating ability of FIG. 1 is shown. It shall be explained in advance that, in FIG. 6, the dry discoloration elements 5 are sketched by dashed lines. In this embodiment of FIG. 6, the desiccant container with moisture-indicating ability 50 is largely resembled to the desiccant container with moisture-indicating ability 40 of FIG. 5. Thus, the same elements of these two embodiments are labelled by the same number, and details thereabout are omitted herein. Namely, in the following description, only the differences in between would be elucidated.

As shown in FIG. 6, a lateral side of the moisture-indicating portion 83 is not formed ad a peeping structure, while a bottom portion 84 of the desiccant container with moisture-indicating ability 50 is formed as a peeping structure. Thereupon, in this embodiment, through the bottom portion 84 of the desiccant container with moisture-indicating ability 50, a coloring state of the dry discoloration elements 5 in the moisture-indicating portion 83 can be observed.

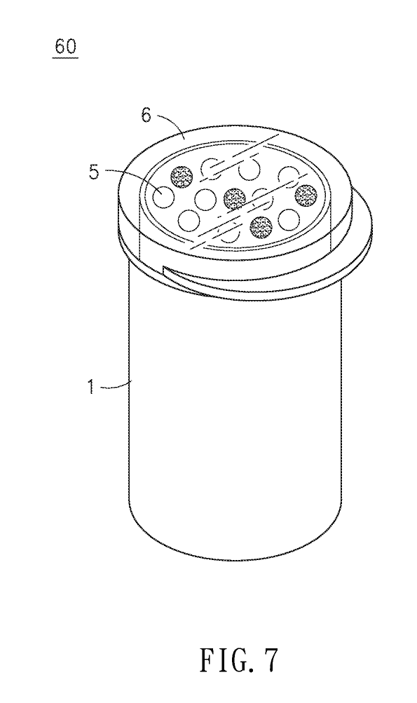

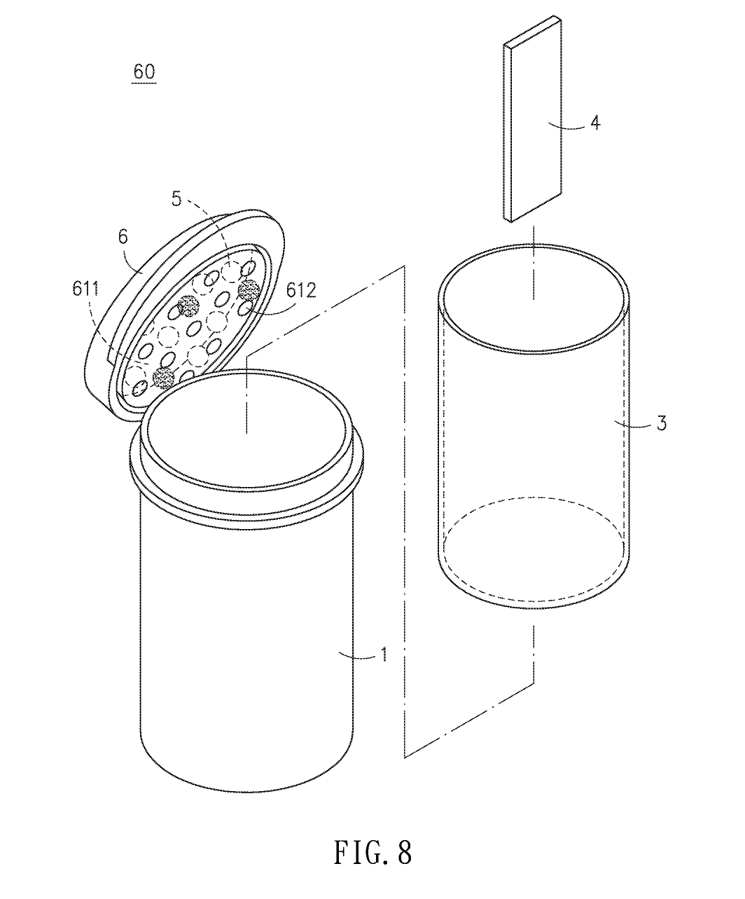

Refer now to FIG. 7 and FIG. 8; where FIG. 7 is a schematic view of a fifth embodiment of the preferred desiccant container with moisture-indicating ability of FIG. 1, and FIG. 8 is a schematically exploded view of FIG. 7.

In this embodiment, the desiccant container with moisture-indicating ability 60 includes a container body 1, an inner container body 3, a cover member 6 and a plurality of dry discoloration elements 5. The inner container body 3 is to store a plurality of biological test pieces 4. The container body 1 is to accommodate the inner container body 3. The cover member 6 for engaging exteriorly the container body 1 is structured to include a moisture-indicating portion 611. The moisture-indicating portion 611 is formed as a peeping structure made of a transparent material. The cover member 6 is further furnished with a plurality of ventilation holes 612 for connecting spatially the moisture-indicating portion 611 and the inner container body 3 in the container body 1. The plurality of dry discoloration elements 5 are located in the moisture-indicating portion 611, and the dry discoloration element 5 is applied to absorb moisture and then discolor.

Upon the aforesaid arrangement, through the moisture-indicating portion 611 of the cover member 6, a coloring state of the dry discoloration elements 5 in the moisture-indicating portion 612 can be observed.

In a further embodiment not shown here, the dry discoloration element 5 is formed as a non-translucent object, which can block the lights from the cover member 6 to radiate the biological test pieces 4 in the inner container body 3 so as to maintain the quality of the biological test pieces 4.

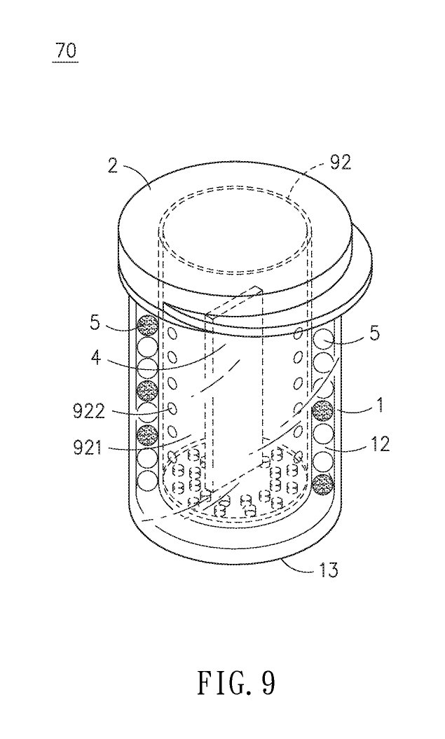

Referring now to FIG. 9, a schematic view of a sixth embodiment of the preferred desiccant container with moisture-indicating ability of FIG. 1 is shown.

In this embodiment, the desiccant container with moisture-indicating ability 70 includes a container body 1, an inner container body 92, a cover member 2 and a plurality of dry discoloration elements 5. The container body 1 is to accommodate the inner container body 92. The inner container body 92 has an accommodation space 921 for storing a plurality of biological test pieces 4. A moisture-indicating portion 12 is laterally formed between a periphery of the inner container body 92 and an inner wall of the container body 1. The inner container body 92 is further furnished with a plurality of ventilation holes 922 for communicating spatially with the moisture-indicating portion 12. The plurality of dry discoloration elements 5 are disposed in the moisture-indicating portion 12 so as to maintain the dryness inside the desiccant container with moisture-indicating ability 10 by having the dry discoloration elements 5 to absorb moisture and then to indicate the dampness by discoloring.

The lateral side of the container body 1 that defines the moisture-indicating portion 12 is a transparent and translucent structure made up by a transparent material and a translucent material. The bottom portion 13 of the container body 1 is formed as a non-transparent and non-translucent structure made up by a non-transparent material and a non-translucent material. The cover member 2 for engaging exteriorly the container body 1 is formed as a non-transparent and non-translucent structure made up by a non-transparent material and a non-translucent material. Thus, the desiccant container with moisture-indicating ability 70 of this embodiment is a structure being transparent at a middle portion but non-transparent and non-translucent at a top and a bottom portion.

Upon the aforesaid arrangement, through the moisture-indicating portion 12 located at lateral side of the container body 1, a coloring state of the dry discoloration elements 5 in the moisture-indicating portion 12 can be observed.

Now, the desiccant container with moisture-indicating ability of the present invention is well elucidated via the aforesaid description and drawings from FIG. 1 to FIG. 9. In one embodiment, the inner container body is formed as a non-translucent structure made of a non-translucent material, such that the biological test pieces inside the inner container body can avoid direct exposure to the lights, and thus the quality of the biological test pieces can be assured. In another embodiment, the container body provides the accommodation portion to receive the inner container body, in which the accommodation portion is formed as a non-translucent structure made of a non-translucent material. By providing the non-translucent structure to the container body, the inner container body can be prevented from irradiation of sunshine, and thus light irradiation upon the biological test pieces in the inner container body can be effectively avoided. Furthermore, the cover member can be formed as a non-translucent structure made of a non-translucent material. By providing the non-translucent cover member, sunshine through the cover member (i.e. irradiation from top of the desiccant container with moisture-indicating ability) can be inhibited, such that the biological test pieces inside the inner container body can be away from light irradiations.

In summary, in the desiccant container with moisture-indicating ability of the present invention, by providing different peeping structures to various portions of the desiccant container, it can be easily inspected whether or not the dry discoloration elements in the desiccant container have already been discolored, and further to determined, by judging colors of the dry discoloration elements, if or not the biological test pieces thereinside are damped or moisturized.

Further, beside the dry discoloration elements are able to maintain the dryness inside the desiccant container, they would be discolored after being damped or absorbing moisture. Thus, even non-professional consumers or salesmen can easily determine if or not the biological test pieces inside the desiccant container is damped, by judging the coloring of the water glass (i.e. the dry discoloration elements).

In addition, by providing the non-translucent structures to different portions of the desiccant container, irradiation upon the biological test pieces can be effectively avoided, and thus the quality of the biological test pieces can be ensured.

While the present invention has been particularly shown and described with reference to a preferred embodiment, it will be understood by those skilled in the art that various changes in form and detail may be without departing from the spirit and scope of the present invention.

What is claimed is:

1. A desiccant container with moisture-indicating ability, comprising:
an inner container body for storing a plurality of biological test pieces;
a container body, including an accommodation portion to accommodate the inner container body, a moisture-indicating portion being formed between the inner container body and the container body;
a cover member, engaging exteriorly the container body; and
a plurality of dry discoloration elements, disposed in the moisture-indicating portion, each of the plurality of dry discoloration elements being used to absorb moisture and then discolor, at least one of the inner container body and the container body being formed as a peeping structure made of a transparent material for inspecting coloring of each of the plurality of dry discoloration elements in the moisture-indicating portion.

2. The desiccant container with moisture-indicating ability of claim 1, wherein the accommodation portion of the container body is formed as a non-translucent structure made of a non-translucent material, and the inner container body is formed as another non-translucent structure made of another non-translucent material.

3. The desiccant container with moisture-indicating ability of claim 1, wherein each of the plurality of dry discoloration elements includes a discoloration-type silicone desiccant.

4. A desiccant container with moisture-indicating ability, comprising:
an inner container body for storing a plurality of biological test pieces;
a container body, including an accommodation portion to accommodate the inner container body, a moisture-indicating portion being formed between the inner container body and a bottom portion of the container body, the accommodation portion being formed as a non-peeping structure made of a non-transparent material, the moisture-indicating portion being formed as a peeping structure made of a transparent material;
a cover member, engaging exteriorly the container body; and
a plurality of dry discoloration elements, disposed in the moisture-indicating portion, each of the plurality of dry discoloration elements being used to absorb moisture and then discolor, coloring of each of the plurality of dry discoloration elements being inspected through the moisture-indicating portion.

5. The desiccant container with moisture-indicating ability of claim 4, wherein the accommodation portion of the container body is formed as a non-translucent structure made of the non-translucent material, and the inner container body is formed as another non-translucent structure made of another non-translucent material.

6. The desiccant container with moisture-indicating ability of claim 4, wherein each of the plurality of dry discoloration elements includes a discoloration-type silicone desiccant.

7. A desiccant container with moisture-indicating ability, comprising:
an inner container body for storing a plurality of biological test pieces;
a container body for accommodating the inner container body;
a cover member, engaging exteriorly the container body, including a moisture-indicating portion formed as a peeping structure made of a transparent material; and
a plurality of dry discoloration elements, disposed in the moisture-indicating portion, each of the plurality of dry discoloration elements being used to absorb moisture and then discolor, coloring of each of the plurality of dry discoloration elements being inspected through the moisture-indicating portion.

8. The desiccant container with moisture-indicating ability of claim 7, wherein the container body is formed as a non-translucent structure made of a non-translucent material, and the inner container body is formed as another non-translucent structure made of another non-translucent material.

9. The desiccant container with moisture-indicating ability of claim 7, wherein each of the plurality of dry discoloration elements includes a discoloration-type silicone desiccant.
